(19) United States
(12) Patent Application Publication
(10) Pub. No.: US 2013/0206818 A1
(43) Pub. Date: Aug. 15, 2013

(54) SYSTEM AND METHOD FOR HOLDING MATERIALS HAVING ARCUATE SURFACES IN PLACE FOR FRICTION STIR WELDING OR PROCESSING

(71) Applicant: MEGASTIR TECHNOLOGIES LLC, (US)

(72) Inventors: Paul T. Higgins, Provo, UT (US); David Rosal, West Bountiful, UT (US); Samuel C. Sanderson, Alpine, UT (US); Russell J Steel, Salem, UT (US); Scott M. Packer, Alpine, UT (US); Jeremy Peterson, Cedar Hills, UT (US); Steve W. Larsen, Payson, UT (US); Jonathan A. Babb, West Jordan, UT (US)

(73) Assignee: MEGASTIR TECHNOLOGIES LLC, PROVO, UT (US)

(21) Appl. No.: 13/731,489

(22) Filed: Dec. 31, 2012

Related U.S. Application Data
(60) Provisional application No. 61/581,955, filed on Dec. 30, 2011.

(51) Int. Cl. B23K 20/12

(52) U.S. Cl. CPC B23K 20/128
USPC 228/114; 228/112.1; 228/2.1

(57) ABSTRACT

A system and method for holding a friction stir processing material in place on a substrate having a curved surface for the purpose of mixing the friction stir processing material into the curved substrate using a solid-state process, wherein the system includes selecting one of a variety of mechanical means of attaching the friction stir processing material to the substrate that will enable friction stir processing to be performed that is economical, efficient and safe.

### CROSS REFERENCE TO RELATED APPLICATIONS

This document claims priority to and incorporates by reference all of the subject matter included in the provisional patent application docket number 5097.SMII.PR, having Ser. No. 61/581,955, and filed Dec. 30, 2011.

### BACKGROUND OF THE INVENTION

1. Field of the Invention

This invention relates generally to friction stir processing. More specifically, the present invention is a method and system for enabling a friction stir processing material to be mixed into an arcuate substrate using a solid state process, wherein the method discloses various methods of clamping or firmly holding in position the friction stir processing material while it is being friction stir processed into the arcuate substrate.

2. Description of Related Art

Friction stir welding (hereinafter “FSW”) is a technology that has been developed for welding metals and metal alloys. The FSW process often involves engaging the material of two adjoining workpieces on either side of a joint by a rotating stir pin or spindle. Force is exerted to urge the spindle and the workpieces together and frictional heating caused by the interaction between the spindle and the workpieces results in plasticization of the material on either side of the joint. The spindle is traversed along the joint, plasticizing material as it advances, and the plasticized material left in the wake of the advancing spindle cools to form a weld.

FIG. 1 is a perspective view of a tool being used for friction stir welding that is characterized by a generally cylindrical tool 10 having a shoulder 12 and a pin 14 extending outward from the shoulder. The pin 14 is rotated against a workpiece 16 until sufficient heat is generated, at which point the pin of the tool is plunged into the plasticized workpiece material. The workpiece 16 is often two sheets or plates of material that are butted together at a joint line 18. The pin 14 is plunged into the workpiece 16 at the joint line 18.

The frictional heat caused by rotational motion of the pin 14 against the workpiece material 16 causes the workpiece material to soften without reaching a melting point. The tool 10 is moved transversely along the joint line 18, thereby creating a weld as the plasticized material flows around the pin from a leading edge to a trailing edge. The result is a solid phase bond 20 at the joint line 18 that may be generally indistinguishable from the workpiece material 16 itself, in comparison to other welds.

It is observed that when the shoulder 12 contacts the surface of the workpieces, its rotation creates additional frictional heat that plasticizes a larger cylindrical column of material around the inserted pin 14. The shoulder 12 provides a forging force that contains the upward metal flow caused by the tool pin 14.

During FSW, the area to be welded and the tool are moved relative to each other such that the tool traverses a desired length of the weld joint. The rotating FSW tool provides a continual hot working action, plasticizing metal within a narrow zone as it moves transversely along the base metal, while transporting metal from the leading face of the pin to its trailing edge. As the weld zone cools, there is typically no solidification as no liquid is created as the tool passes. It is often the case, but not always, that the resulting weld is a defect-free, recrystallized, fine grain microstructure formed in the area of the weld.

Previous patent documents have taught the benefits of being able to perform friction stir welding with materials that were previously considered to be functionally unweldable. Some of these materials are non-fusion weldable, or just difficult to weld at all. These materials include, for example, metal matrix composites, ferrous alloys such as steel and stainless steel, and non-ferrous materials. Another class of materials that were also able to take advantage of friction stir welding is the superalloys. Superalloys can be materials having a higher melting temperature bronze or aluminum, and may have other elements mixed in as well. Some examples of superalloys are nickel, iron-nickel, and cobalt-based alloys generally used at temperatures above 1000 degrees F. Additional elements commonly found in superalloys include, but are not limited to, chromium, molybdenum, tungsten, aluminum, titanium, niobium, tantalum, and rhenium.

It is noted that titanium is also a desirable material to friction stir weld. Titanium is a non-ferrous material, but has a higher melting point than other nonferrous materials.

The previous patents teach that a tool is needed that is formed using a material that has a higher melting temperature than the material being friction stir welded. In some embodiments, a superabrasive was used in the tool.

The embodiments of the present invention are generally concerned with these functionally unweldable materials, as well as the superalloys, and are hereinafter referred to as “high melting temperature materials” (HMTM) throughout this document. However, the principles of the present invention are also applicable to lower melting temperature materials such as aluminum and other metals and metal alloys that are not considered part of the high melting temperature materials.

Recent advancements in FSW technologies have resulted in tools that can be used to join high melting temperature materials such as steel and stainless steel together during the solid state joining processes of friction stir welding.

As explained previously, this technology involves using a special friction stir welding tool. FIG. 2 shows a polycrystalline cubic boron nitride (PCBN) tip 30, a locking collar 32, a thermocouple set screw 34 to prevent movement, and a shank 36. Other designs of this tool are also shown in the prior art of the inventors, and include monolithic tools and other designs.

When this friction stir welding tool is used, it is effective at friction stir welding of various materials. This tool design is also effective when using a variety of tool tip materials besides PCBN and PCD (polycrystalline diamond). Some of these materials include refractories such as tungsten, rhenium, iridium, titanium, molybdenum, etc.

The inventors have been the leader in developing friction stir welding technology for use with high melting temperature alloys such as steel, stainless steel, nickel base alloys, and many other alloys. This technology often requires the use of a Polycrystalline cubic boron nitride tool, a liquid cooled tool holder, a temperature acquisition system, and the proper equipment to have a controlled friction stir welding process.

Once the technology had been established as a superior method for joining these materials, MegaStir Technologies LLC began searching for applications that would greatly benefit from this technology. One of the largest applications for friction stir welding (FSW) is joining arcuate surfaces such as pipelines.

Advanced high strength steels (AHSS) are being implemented into pipelines because less material is needed, higher strength properties are obtained and the total pipeline cost can be lower. The difficulty with AHSS lies in the conventional fusion welding methods being used. It is accepted in the industry that every pipeline joint contains a defect or crack. These defects are accepted because they cannot be eliminated even with sophisticated automated fusion welding systems. Welding AHSS is far more difficult than existing pipeline steels because the material composition inherently causes more fusion welding defects.

FSW has now been established as a viable technology to join pipe segments. A friction stir welding machine to join pipe segments has been developed. A rotating tool plunges into a joint as it creates frictional heat. Once the tool has plunged into the workpiece cross section, the tool is caused to travel circumferentially around the pipes while the joint is “stirred” together. The FSW tool is then retracted and the machine is moved along the pipe to the next pipe joint to be friction stir welded.

One of the recent observations made during FSW of HMTM is the material that flows around the tool during the process may be altered to have a finer grain structure than the base material being joined. The properties of the joint may be further enhanced in some high melting temperature alloys because a very short process time at temperature of the stirred material can create a much faster quench and higher hardness, something that cannot be achieved during any known heat treating method. These observations have given rise to a new technology that will be referred to hereinafter as Friction Stir Processing (FSP).

Certain HMTM can be friction stir processed to have very high hardness and toughness properties. This is accomplished by simultaneously refining the grain structure and solution hardening the material during FSP. There are patents pending for this revolutionary material processing method as well as articles published in reputable journals describing the science behind this invention. FSP is creating extreme interest in the oil and gas industry, nuclear industry, automotive industry, aerospace industry and construction industry because it can be used to dramatically increase a material's hardness and toughness. Prior to this technology, there was no known way to achieve these properties together in one material. For example, FSP may create a material or local portion of material with the hardness of tungsten carbide while maintaining the ductility of mild steel. One example of a commercial product being sold utilizing this technology is a FRICTION FORGED™ hand held knife. This knife utilizes FSP technology and has the data and publications to show how sharpness, hardness, and toughness are superior to all other knives throughout the world.

FSP has been developed using typical FSW equipment and tooling methods. Most facilities currently performing FSW for either research or production are typically joining flat sections. Some examples of this include ship decking, train decks and flooring, heat exchangers and flat panel joining. The loads applied to the FSW tool may be typically several tons in the axial direction with lateral tool forces up to 50% of the axial force. In working with flat plate and flat sections, the work pieces may be held by commercially available clamps that may be screw mounted to a table. These clamps may be either mechanically or hydraulically tightened. Since FSW is a machine process much like conventional metal machining, these conventional clamps work well. In some cases, additional clamps are required because increased tool loads are required for FSW of thicker sections.

In this document, FSP refers to any solid state joining method. There are no commercially available holding or clamping systems that may be adapted to FSP on curved or arcuate surfaces. Custom clamping systems may be designed and manufactured that utilize a specified arcuate table and attach the same clamping system used in flat applications, however these systems are not practical because they may not accommodate variable radii or complex arcuate surfaces.

In addition, FSP often requires one or more material types to be attached to or clad on to the arcuate surface of another material, as well as post processing requirements that add cost and waste. This further complicates not only how a base workpiece is held to resist FSP tool processing loads, but the FSP material that is positioned on its surface. Also, the thermal expansion of the material or materials to be friction stir processed on to the base workpiece are often different than the base workpiece material and holding the materials in place must account for differences in thermal expansion. Creative and novel methods are therefore needed to economically hold materials in place on an arcuate surface to be friction stir processed.

### BRIEF SUMMARY OF THE INVENTION

It is an object of the present invention to provide a method for enabling materials that have flat or arcuate surfaces to be held in place against a substrate also having a flat or arcuate surface in order to perform friction stir processing.

The present invention is a system and method for holding a friction stir processing material in place on a substrate having a curved surface for the purpose of mixing the friction stir processing material into the curved substrate using a solid-state process, wherein the system includes selecting one of a variety of mechanical means of attaching the friction stir processing material to the substrate that will enable friction stir processing to be performed that is economical, efficient and safe.

These and other objects, features, advantages and alternative aspects of the present invention will become apparent to those skilled in the art from a consideration of the following detailed description taken in combination with the accompanying drawings.

### BRIEF DESCRIPTION OF THE SEVERAL VIEWS OF THE DRAWINGS

FIG. 1 is a perspective view of a tool as taught in the prior art for friction stir welding.

FIG. 2 is a perspective view of a removable polycrystalline cubic boron nitride (PCBN) tip, a locking collar and a shank.

FIG. 3 is a perspective view that shows a concept of how a FSP material is inserted in a pocket of the FSP substrate such that the FSP material is flush with the substrate.

FIG. 4 is a perspective view that shows FSP material positioned around the end of a drill pipe joint prior to securing the FSP material to the pipe.

FIG. 5 is a perspective view that shows FSP material positioned and held in place with rings containing set screws to apply a clamping force.

FIG. 6 is a perspective view that shows the FSP material positioned and held in place by bands of the same or different material that can later be removed.

FIG. 7 is a perspective view that shows two possibilities of how the FSP bands engage with the FSP material to hold and maintain position on the substrate.

FIG. 8 is a perspective view that shows how the FSP material is held in placing using friction bit joining. Similar holding can be achieved using interference mechanical fasteners (i.e. press fit pins, rivets, etc.)

FIG. 9 is a perspective view that shows how the FSP material is held in placing using friction bit joining.

FIG. 10 is a perspective view that shows how pinch rollers can be used as a dynamic holding system to keep the FSP material positioned.

FIG. 11 is a perspective view that shows how a cable or chain can be used to apply dynamic tension that holds the FSP material to the substrate.

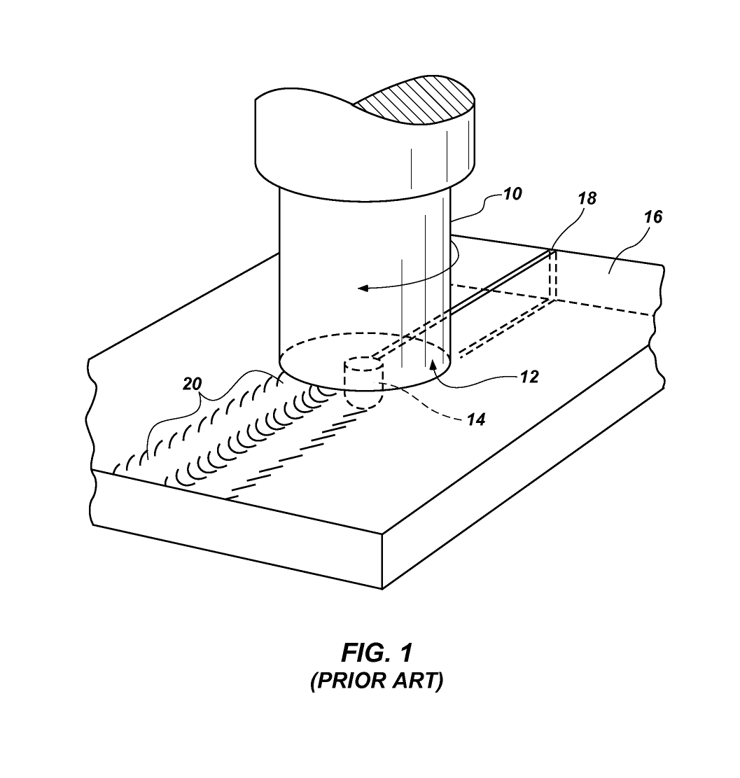

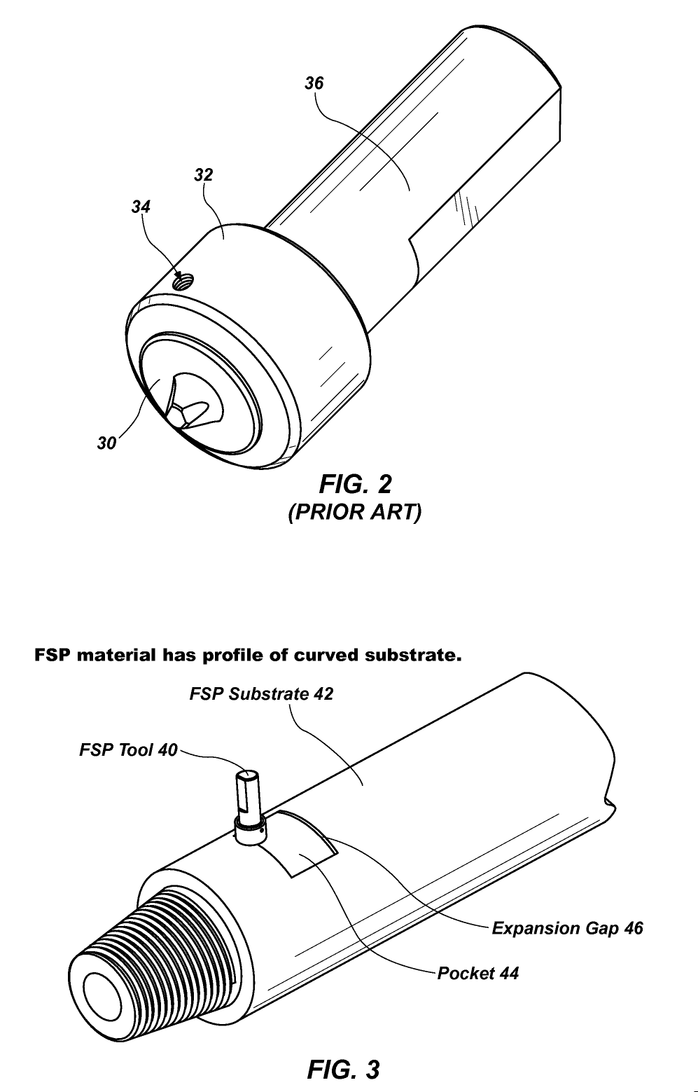

### DETAILED DESCRIPTION OF THE INVENTION

Reference will now be made to the details of the invention in which the various elements of the present invention will be described and discussed so as to enable one skilled in the art to make and use the invention. It is to be understood that the following description is only exemplary of the principles of the present invention, and should not be viewed as narrowing the claims that follow.

There may not be a “one method fits all” solution to positioning and holding a material in place over an arcuate surface for FSP. Therefore, a family of innovative concepts has been developed that may economically, efficiently, and safely solve the problems presented by friction stir processing on an arcuate surface. It is important to recognize that these concepts can be used in combination with each other and embodiments of these concepts may be used without departing from the scope of the invention.

Improving drill pipe abrasion resistance is an example of a commercial application that may benefit from friction stir processing, and consequently may require the embodiments of the present invention to become viable. As a drill bit drills into the earth it must rotate, and the many sections of pipe that are screwed together forming the drill string also rotate to enable the drilling process. Inevitably, the constant rotating drill pipe wears on the diameter and must be continually replaced. Replacing drill pipe has an extreme economic cost and it becomes a logistical hardship when supplying the many drilling rigs throughout the world.

Drilling also takes place with a drill string extending through metal casing (tubing) which has been cemented in the sections of the hole that have been drilled. Casing is used to prevent the hole from collapsing on itself as deeper hole sections are drilled. Not only does the drill string wear, but the drill string rotation also causes the casing to wear such that casing failure can occur. This problem becomes far more pronounced when horizontal drilling takes place. As the drill string starts to curve in the horizontal direction, it wears the curved portion of the casing. If the casing fails, then drilling in that location must stop and the well investment is likely lost.

Currently, a fusion or melting/solidification process called hardbanding is used to improve the wear resistance of drill pipe. Fusion hardbanding is performed by melting a metal with hard particles of carbide mixed in and applying this mixture to the surface of the pipe. Once the molten mixture has solidified, the surface appearance of the pipe where hardbanding has been used is very rough. During the drilling operation, the hard particles in the area of hardbanding may cause unwanted cutting, grinding or machining of the casing during drilling. This problem is so extreme that large electromagnets may be used at drill rigs to remove pieces of the casing that are now floating in the drilling fluid. These pieces of the casing may be machined away from the casing during drilling by the drill pipe making contact with the portion of the casing where hardbanding was performed.

As only one of many possible examples, a drill pipe connection having an arcuate surface may be used to illustrate how material to be used for hardbanding may be friction stir processed while positioned and held in place on an arcuate surface.

FIG. 3 illustrates in a perspective view a first embodiment of the present invention. This figure shows a friction stir processing (FSP) substrate 42 having a curved surface. The FSP substrate 42 may be a pipe or any other workpiece that has a curved surface. The FSP substrate 42 may have a pocket 44 or indentation that is formed in the curved surface. The method of forming the pocket 44 is not considered to be a patentable aspect of the invention. What is important is that the pocket 44 be created in the curved surface of the FSP substrate 42. An outline of the pocket 44 is shown on the FSP substrate 42. The pocket 44 may conform the curved surface of the FSP substrate 42.

A friction stir processing (FSP) material 48 is then disposed within the pocket 44. The FSP material 48 may be formed so that it conforms to the curved surface of the FSP substrate 42. The FSP material 48 may be flush with the curved surface of the FSP substrate 42, but it is not required.

The FSP material 48 may be held in place using any appropriate means that include, but should not be considered as limited to, diffusion bonding, an interference fit, a rivet, a tack weld, an adhesive and brazing material to be removed later or to be friction stir processed into the FSP substrate 42 and the FSP material 48.

The FSP material 48 that will be friction stir processed into the FSP substrate 42 may be a different material than the FSP substrate. For example, the FSP material 48 may include a material or materials that are harder than the FSP substrate 42 in order to create a segment on the FSP substrate 42 that is harder than the original FSP substrate material. The FSP material 48 may have properties or qualities that are different from the FSP substrate 42 to thereby enhance the FSP substrate. This process of friction stir processing a harder material into the original FSP substrate 42 may accomplish hardbanding on the FSP substrate.

The pocket 44 may be made larger than the FSP material 48 that is disposed within the pocket. By making the pocket 44 larger than the substrate material 48, an expansion gap 46 may be provided that allows for expansion of the FSP substrate 42, the FSP material 48 or both. Expansion of any material may occur as the FSP substrate 42 and the FSP material 48 are heated. Expansion of the FSP material 48 may be in one or more directions, requiring one of more degrees of freedom for expansion. FIG. 3 also shows a friction stir processing tool 40 that may be used to friction stir process the FSP material 48 into the FSP substrate 42.

It should be understood that the pocket 44 may extend only partially around the FSP substrate 42 or it may extend around the entire circumference of the FSP substrate 42. Furthermore, there may be multiple pockets 44 in multiple locations on the FSP substrate 42.

The FSP material 48 may have a contact surface that is normal to the curved surface of the FSP substrate 42. The FSP tool 40 may be a consumable tool or a non-consumable tool.

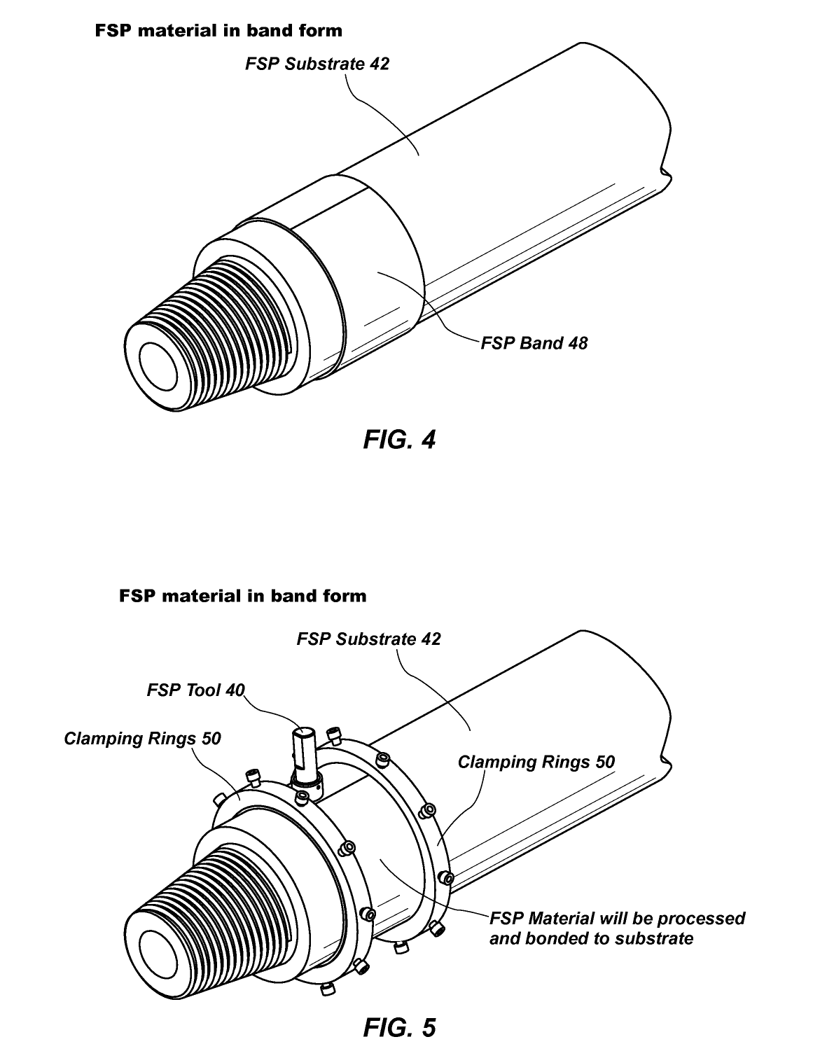

FIG. 4 is a perspective view that shows an alternative embodiment of the present invention. Specifically, a pocket 44 may not be provided in the FSP substrate 42. Instead, the FSP material 48 may be disposed on a curved surface of the FSP substrate 42. This figure shows that the FSP material is now formed as an FSP band 48. The FSP band 48 may be a strip of material, or it may already form a complete tube that fits around the FSP substrate 42.

The FSP band 48 may be secured to the FSP substrate 42 using any means that are appropriate. FIG. 4 shows an end of a drill pipe that forms the FSP substrate 42. Before the FSP band 48 is friction stir processed into the FSP substrate 42, it may need to be secured so that it does not move out of position during friction stir processing.

FIG. 5 is a perspective view of one embodiment of the present invention for holding the FSP band 48 in place while performing friction stir processing. This figure shows that clamping rings 50 may be disposed on either end of the FSP band 48. The clamping rings 50 may include set screws 70 to hold the clamping rings in place on top of the FSP band 48. It should be understood that only a single clamping ring 50 may be necessary to hold the FSP band 48.

While this embodiment shows the use of set screws 70, this embodiment may use any appropriate means for holding the clamping rings 50 in place, including a joint and latch assembly to be radially removed without sliding down a long axis of a cylindrical FSP substrate 42. The clamping rings 50 may also be comprised of consumable rings or arcs made from a material that can be fusion joined to the curved surface of the FSP substrate 42 to trap the FSP band 48, and then subsequently removed using mechanical methods of removal such as machining, grinding and other post-processing techniques that are known to those skilled in the art.

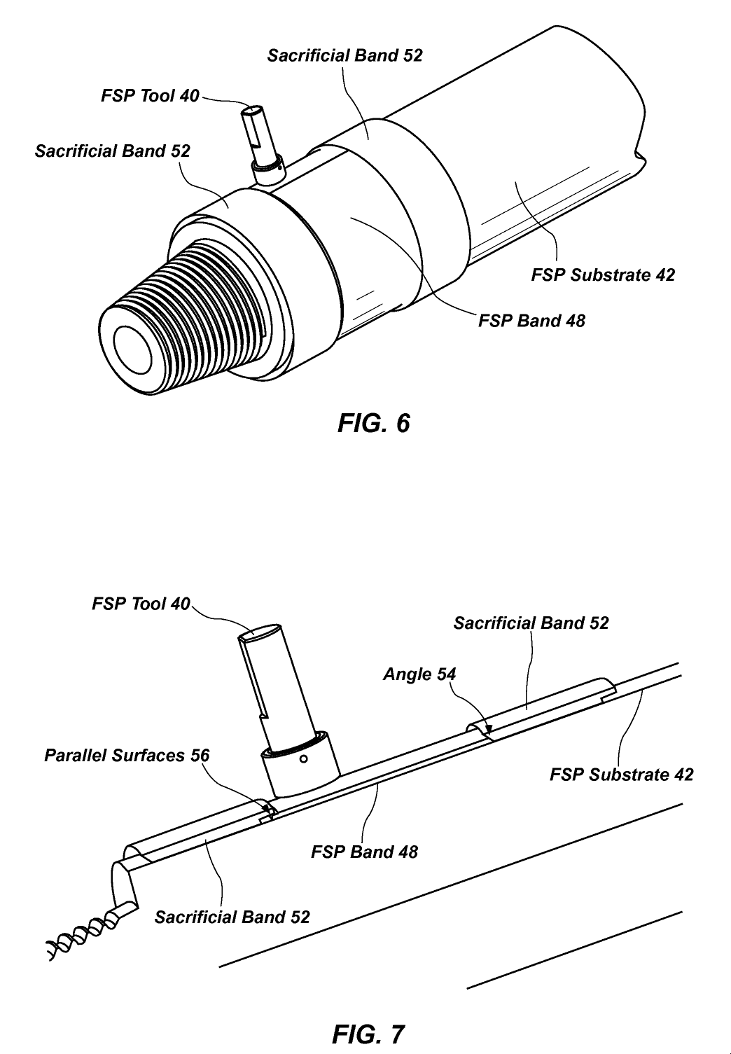

FIG. 6 is a perspective view of a different embodiment for holding the FSP band 48 in place on the FSP substrate 42 while the FSP tool 40 is used for friction stir processing. This embodiment shows that one or more sacrificial bands 52 may be disposed on one or both ends of the FSP band 48. The sacrificial bands 52 may be comprised of any suitable material. The sacrificial bands 52 may be friction stir processed into the FSP substrate 42, or they may be all or partially removed by any appropriate post-processing means.

FIG. 7 is a close-up and perspective view that shows detail regarding how the sacrificial bands 52 may hold the FSP band 48 in place for friction stir processing. In one embodiment, the sacrificial band 52 forms an angle 54 with the FSP band 48. The FSP band 48 may have a complimentary angle 54 relative to the angle on the sacrificial band 52.

In an alternative embodiment, FIG. 7 shows that the sacrificial band 52 and the FSP band 48 may have complimentary parallel surfaces 56 which overlap. The overlapping parallel surfaces 56 enable the sacrificial band 52 to hold the FSP band 48 in place on the FSP substrate 42. One advantage of the parallel surfaces 56 is that a gap 66 may be provided that allows for thermal expansion of the FSP band 48, the sacrificial band 52, or both.

Other means may also be provided for holding the FSP band 48 in place. These other means include but should not be considered as limited to press fit pins, rivets and other means known to those skilled in the art. What is important is that any means of mechanical entrapment or attachment may be used to hold the FSP band 48 in place.

FIG. 8 is a perspective view of another embodiment of the present invention. The FSP band 48 may be attached at one or more locations to the FSP substrate 42 before it is friction stir processed. In this alternative embodiment, friction stir joining is used to attach them together. For example, a friction stir bit 58 may be used to cut into the FSP band 48 and the FSP substrate 42. After cutting through both materials using a high rotational rate of speed, the rotational speed of the friction stir bit 58 may be decreased and may cause solid state processing of the FSP band 48, the FSP substrate 42 and the friction stir bit 58, and may enable solid-state bonding between them.

The portion of the friction stir bit 58 that rises above the FSP band 48 may be sheared off or left behind to be friction stir processed into the FSP band and the FSP substrate 42. It should also be understood that holding of the FSP band 48 to the FSP substrate 42 may also be achieved using some sort of interference mechanical fastener (i.e. press fit pins, rivets, etc.).

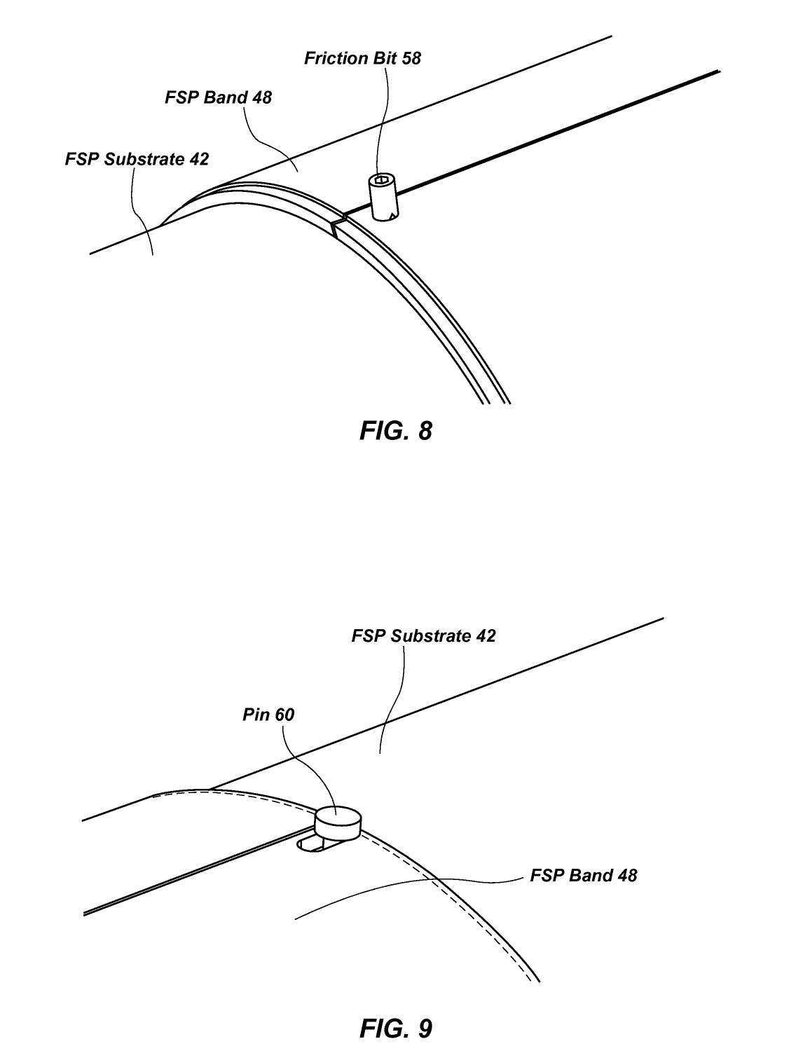

FIG. 9 is a perspective view that shows an alternative embodiment of the present invention. A pin 60 may be used to secure the FSP band 48 to the FSP substrate 42. The pin 60 is inserted through a hole 68 in the FSP band 48. The hole 68 may be lengthened in a direction that enables thermal expansion of the FSP band 48 during friction stir processing. For example, the hold 68 may be expanded along a long axis of the FSP substrate 42.

The pin 60 may be attached to the FSP substrate 42 using an interference fit, screw threads, or any other appropriate means for attaching the pin. It may also be necessary to drill a hole into the FSP substrate 42, with or without threads. The pin 60 may or may not have a head.

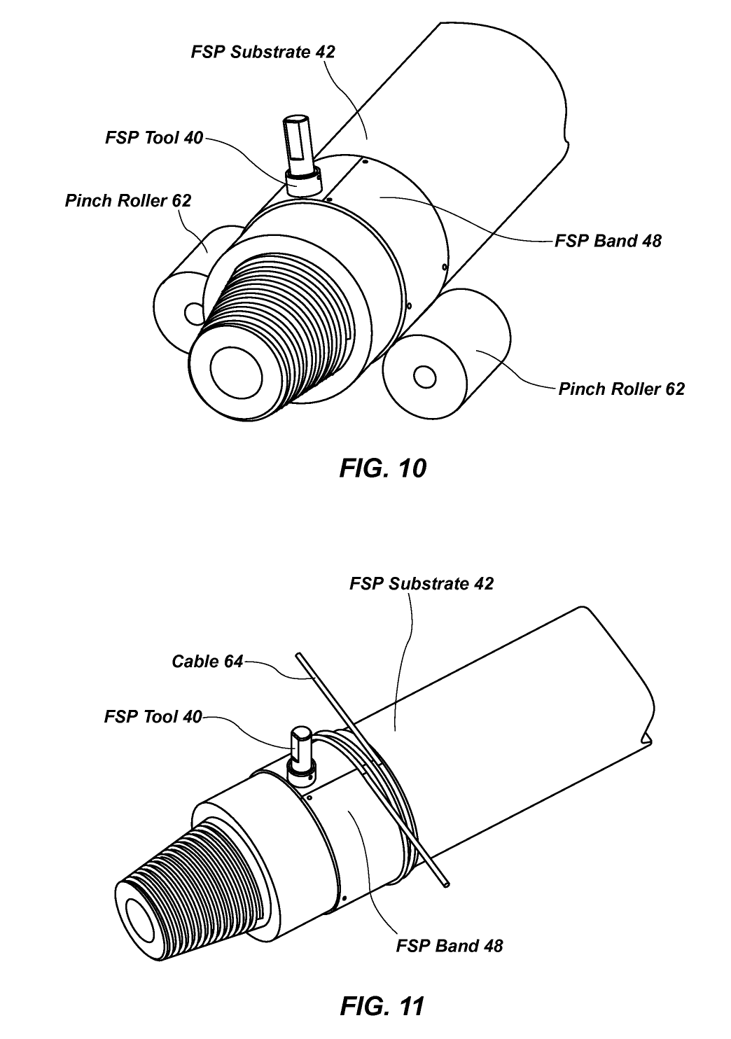

FIG. 10 is a perspective view of another embodiment of the present invention. In this embodiment, one or more pinch rollers 62 may be used to hold the FSP band 48 against the FSP substrate 42. The FSP tool 40 may press the FSP band 48 against the pinch rollers 62 as it performs friction stir processing. The pinch rollers 62 may form a dynamic holding system to keep the FSP band 48 in the correct position on the FSP substrate 42.

FIG. 11 is a perspective view of another embodiment of the present invention that enables the FSP band 48 to be held in position on the FSP substrate 42. In this embodiment, a cable 64 or chain may be used to apply dynamic tension that holds the FSP band 48 in place. The cable 64 may manually or automatically apply a tightening force around the FSP band 48 to apply force around the FSP band 48 and clamp it into place.

It should be understood that for any embodiments of the present invention, a run-off tab may be used to eliminate any hole from the FSP tool 40 after it completes friction stir processing of the FSP band 48 into the FSP substrate 42.

Another aspect of the present invention may be the application of liquid or air to the FSP band 48 and the FSP substrate 42 in order to provide cooling. Cooling may help to minimize thermal expansion during friction stir processing.

Another embodiment of the invention is to cut threads on the OD of the FSP substrate 42 and to cut complimentary threads on the ID of the FSP band 48. The FSP band 48 is then screwed onto the FSP substrate 42. The threads may be consumed during friction stir processing.

It is to be understood that the above-described arrangements are only illustrative of the application of the principles of the present invention. Numerous modifications and alternative arrangements may be devised by those skilled in the art without departing from the spirit and scope of the present invention. The appended claims are intended to cover such modifications and arrangements.

What is claimed is:

1. A method for holding and friction stir processing a material into a substrate having a curved surface, said method comprising:
1) providing a substrate having a curved surface;
2) providing a friction stir processing material that is to be mixed into the substrate using a solid-state joining process to thereby modify properties of the substrate;
3) positioning and attaching the friction stir processing material against the substrate at a desired location; and
4) friction stir processing the friction stir processing material into the substrate while preventing the friction stir processing material from moving.

2. The method as defined in claim 1 wherein the method further comprises forming a pocket in the curved surface in which the friction stir processing material can be disposed.

3. The method as defined in claim 2 wherein the method further comprises disposing the friction stir processing material into the pocket using an interference fit.

4. The method as defined in claim 3 wherein the method further comprises providing at least one gap along at least one edge of the friction stir processing material when it is disposed within the pocket to thereby enable thermal expansion of the friction stir processing material in at least one direction along a length of the friction stir processing material during friction stir processing.

5. The method as defined in claim 2 wherein the method further comprises manufacturing the friction stir processing material to have a contact surface that is normal to the curved surface of the substrate in the pocket.

6. The method as defined in claim 1 wherein the method further comprises making the pocket extend only partially around a circumference of the substrate.

7. The method as defined in claim 1 wherein the method further comprises making the pocket extend around the entire circumference of the substrate to form a groove in the substrate.

8. The method as defined in claim 1 wherein the method further comprises making a plurality of discrete pockets around a circumference of the substrate.

9. The method as defined in claim 1 wherein the method further comprises forming the friction stir processing material as a continuous friction stir processing band that completely encircles a circumference of the substrate.

10. The method as defined in claim 9 wherein the method further comprises attaching the friction stir processing band using at least one detachable ring that surrounds the friction stir processing band and presses against the friction stir processing band using a plurality of set screws in the at least one detachable ring.

11. The method as defined in claim 9 wherein the method further comprises attaching the friction stir processing band using at least one detachable ring that surrounds the friction stir processing band and presses against the friction stir processing band, wherein the at least one detachable ring includes a joint and latch assembly to enable attachment and removal from the friction stir processing band.

12. The method as defined in claim 9 wherein the method further comprises:
1) providing at least one sacrificial band to provide a mechanical means of attachment to hold the friction stir processing band against the substrate; and
2) friction stir processing the friction stir processing band into the substrate.

13. The method as defined in claim 12 wherein the method further comprises removing the at least one sacrificial band after the frictions stir processing band is processed into the substrate.

14. The method as defined in claim 12 wherein the method further comprises selecting the means of mechanical attachment from the group of mechanical attachments comprised of friction bit joining, bolting, riveting, tack welding, brazing, wrapping a cable around the friction stir processing band, using a roller system, and using an adhesive to attach the friction stir processing band to the substrate.

15. A system for holding and friction stir processing a material into a substrate having a curved surface, said system comprising:
a substrate having a curved surface;
a friction stir processing material;
a pocket disposed in the substrate, the pocket conforming to the curved surface, and wherein the pocket provides an interference fit for the friction stir processing material; and
a friction stir processing tool for friction stir processing the friction stir processing material into the substrate.

16. The system as defined in claim 15 wherein the system is further comprised of the friction stir processing material having a contact surface that is normal to the curved surface of the pocket.

17. A system for holding and friction stir processing a material into a substrate having a curved surface, said system comprising:
a substrate having a curved surface;
a friction stir processing material;
a mechanical attachment system for holding the friction stir processing material against the substrate; and
a friction stir processing tool for friction stir processing the friction stir processing material into the substrate.

18. The system as defined in claim 17 wherein the system further comprises the friction stir processing material forming a continuous friction stir processing band that completely encircles a circumference of the substrate.

19. The system as defined in claim 18 wherein the system further comprises:
at least one detachable ring that surrounds the friction stir processing band; and
a plurality of set screws in the at least one detachable ring.

20. The system as defined in claim 18 wherein the system further comprises at least one detachable ring that surrounds the friction stir processing band, the at least one detachable ring having a joint and latch assembly to enable attachment and removal from the friction stir processing band.

21. The system as defined in claim 18 wherein the system further comprises at least one sacrificial band to provide a mechanical means of attachment to hold the friction stir processing band against the substrate, wherein the at least one sacrificial band can be removed after friction stir processing, or it may be processed into the substrate with the friction stir processing band.

22. The system as defined in claim 18 wherein the system further comprises selecting the means of mechanical attachment from the group of mechanical attachments comprised of friction bit joining, bolting, riveting, tack welding, brazing, wrapping a cable around the friction stir processing band, using a roller system, and using an adhesive to attach the friction stir processing band to the substrate.
